(19) United States
(12) Patent Application Publication
(10) Pub. No.: US 2006/0278713 A1
(43) Pub. Date: Dec. 14, 2006

(54) Method and system for high speed optical scanning

(75) Inventors: Bryan L. Olmstead, Eugene, OR (US); Joseph G. Mistkawi, Tigard, OR (US); Larry J. Smith, Eugene, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/446,592

(22) Filed: Jun. 2, 2006

Related U.S. Application Data
(63) Continuation-in-part of application No. 11/150,961, filed on Jun. 13, 2005.

(51) Int. Cl. G06K 7/10

(52) U.S. Cl. 235/462.37

(57) ABSTRACT

Systems and methods for optical scanning, in one configuration, including a torsional dither mechanism having a torsion rod formed of integral construction machined from a single metal piece, magnet and mirror mount attached to the free end of the torsion rod, and electromagnetic drive. The drive comprises a magnet mounted to the magnet mount and a drive coil. Torque is generated on the dither arm as oscillating current is applied to the coil, to preferably drive the torsion rod at a high oscillation speed on the order of 5 KHz. Acoustic noise control is provided by using a combination of elastomeric isolation mounts, a thick wall enclosure and lid for the dither, an electrically resonant dither drive, and mechanically resonant drive control using back EMF from a moving magnet to set the frequency of oscillation of the dither drive.

This application is a continuation-in-part of U.S. application Ser. No. 11/150,961, filed on Jun. 13, 2005, hereby incorporated by reference.

### BACKGROUND

The field of the present disclosure relates to optical readers, and more particularly, to a method and system using a torsional dither for high speed imaging of optical symbols.

Optically reading data or encoded symbols, such as barcode labels, has been used for some time in many applications. Typically, barcodes consist of a series of parallel light and dark rectangle areas of varying widths. Different widths of bars and spaces define different characters in a particular barcode symbology. A barcode label may be read by a scanner that detects reflected and/or refracted light from the bars and spaces comprising the characters. One common method of illuminating the barcode label is by scanning a laser beam. The laser light beam is swept across the barcode label and an optical detector detects the reflected light. The detector generates an electrical signal having an amplitude determined by the intensity of the collected light. Another method of illuminating the barcode label is by use of a uniform light source with the reflected light detected by an array of optical detectors connected to an analog shift register. An electrical signal is generated having an amplitude determined by the intensity of the collected light. As the label is scanned, positive and negative transitions in the electrical signal occur that signify transitions between the bars and spaces.

Area imaging scanners are one type of device for reading optically coded symbols. Area imaging scanners are limited in their depth of field and may require the user to orient the barcode with the bar edges nearly perpendicular to the raster lines. Increased depth of field is possible by using additional hardware to automatically focus the imaging system on the barcode label. This additional hardware increases the complexity and cost of the system. Typically, area imagers have a small field of view that limits the range of the barcode label size for a given combination of imaging sensors and lenses.

There are a few methods that attempt reading barcode labels at any orientation to the scanner, for example, multi-line or complex-pattern laser scanners. A typical type of laser scanner uses a motor with a facet wheel to generate a scan arc that hits various pattern mirrors in order to generate an omnidirectional scan pattern. A light beam is collected from the barcode retro-directively onto pattern mirrors and the facet wheel. The light beam is directed onto a collection mirror or lens and then is focused onto a detector. The scan pattern repeats at the motor rotation speed. The scan pattern consists of “families” of parallel lines due to the angular separation of each facet on the facet wheel. The scan pattern is constrained by using the families of parallel lines. The scan lines must emanate from a point farther out than the scan window. Thus to create the pattern, the scanner needs to be wider than the window in two dimensions. In addition, the facet wheel needs to be large because the light collection is retro-directive. Furthermore, the motor windage is large, causing large power consumption, because of the small number of facets in the wheel. A large amount of space is needed for pattern mirrors to generate omnidirectional scan patterns. Also, a large window is needed to emit the omnidirectional scan pattern wherein these large windows are costly. Finally, there are constraints in the scan patterns due to the multi-sided facet wheel creating families of parallel scan lines. The speed of the facet wheel, which impacts the performance of the scanner, is constrained by its power consumption. The consumption of power increases significantly due to windage losses from the large facet wheel and mechanical integrity constraints of the facet wheel. The optical flatness of mirrors and structural integrity of the facet wheel is compromised by a high speed of rotation.

Fixed barcode scanners having multiple windows capable of reading objects in a variety of orientations have been commercially available for some time. One such “multi-plane” scanner is described in U.S. Pat. No. 6,568,598 which is hereby incorporated by reference. One such a device is the 2002 version of the PSC Scanning, Inc. MAGELLAN® scanner. This multi-plane scanner uses one or more scanned optical beams to generate multiple scan patterns. In addition, this scanner has one or more scan engines and multiple scan windows oriented in different planes from each other. One of the scan windows is oriented horizontally defining a horizontal scan plane and the other is oriented vertically defining a vertical scan plane. In certain configurations, the Magellan® scanner includes a multiple beam source comprised of a laser diode and a beam splitter and a rotating polygon mirror or facet wheel to scan the beam(s) across a plurality of stationary mirrors.

The present inventors have recognized a need for improved systems and methods for optical scanning.

### SUMMARY

The present invention is directed to an optical scanner as well as systems and methods for high speed scanning. A preferred embodiment comprises a high speed optical scanner using a torsional dither mechanism comprised of a torsion rod constructed from a metal piece such as wire stock that is machined to form a central shaft region, a fixed end that is attachable to a base and a free end to which a mirror and magnet mount is connected. The mirror/magnet mount may be formed integrally with the torsion rod or may comprise a separate part formed via casting or other suitable method. The driver drive comprises a magnet mounted to the mirror/magnet mount and a drive coil. The magnet is positioned within an electromagnetic field produced by the coil whereby torque is generated on the dither arm by current in the coil. A driver circuit is connected to the coil to provide oscillating current to the coil providing torque on the dither arm causing the dither arm and hence the scan mirror on the mirror mount to oscillate. The driver circuit senses the motion via induced voltage or back emf generated by the magnet moving in the magnetic field of the electromagnetic circuit. The torsion rod is preferably driven at or near resonance at a high oscillation speed on the order of 5KHz. In one example configuration, an electrically resonant dither drive is constructed with (a) a mechanically resonant drive control using back EMF from a moving magnet to set the frequency of oscillation of the dither drive and (b) acoustic noise control provided by using a combination of elastomeric (e.g. rubber) isolation mounts, a thick wall enclosure and lid for the dither. A laser diode module is provided emitting a laser beam toward the scan mirror, and reflected light from the scan mirror generates an oscillating beam of light as the dither arm is oscillated.

These and other aspects of the disclosure will become apparent from the following description, the description being used to illustrate a preferred embodiment when read in conjunction with the accompanying drawings.

### BRIEF DESCRIPTION OF THE DRAWINGS

FIG. 1 is a perspective and partially exploded view of a high speed ditherer assembly according to a preferred embodiment.

FIG. 2 is a perspective view of the assembly of FIG. 1 on an enlarged scale.

FIG. 3 is a perspective view of the assembly of the FIG. 2 with the mount restraining piece removed.

FIG. 4 is a perspective view of the dither mount assembly according to a preferred embodiment.

FIG. 5 is a perspective view of the dither mount assembly of FIG. 4 with portions removed to illustrate the mounting structure

FIG. 6 is a perspective view of dither arm assembly, including the mirror and magnet, as removed from the dither mount assembly of FIG. 5.

FIG. 7 is a perspective view of the dither arm assembly of FIG. 6 with the mirror and magnet removed.

FIG. 8 is an exploded perspective view of the dither arm assembly of FIG. 7.

FIG. 9 is a perspective view of a machined dither arm according to an alternate embodiment.

FIG. 10 is a perspective view of an alternate dither mount assembly including the dither arm of FIG. 9.

FIG. 11 is a top view of an electromagnetic operation according to a preferred embodiment.

FIG. 12 is a diagrammatic side view of an electromagnetic operation of the ditherer according to a preferred embodiment.

FIGS. 13A and 13B are diagrams illustrating reflection angles of a single scan mirror.

FIGS. 13C and 13D are diagrams illustrating reflection angles of a single scan mirror whereby the scan beam undergoes a double bounce.

FIG. 14 is a diagram of a dither drive circuit according to a preferred embodiment.

FIG. 15 is a side view of a high speed imaging system according to a preferred embodiment.

FIG. 16 is a top view of a high speed imaging system according to a preferred embodiment.

FIG. 17 is a side view of a high speed optical scanner according to an alternate embodiment.

FIG. 18 is a diagrammatic view of an L-shaped scanner according to a preferred embodiment.

### DETAILED DESCRIPTION OF THE PREFERRED EMBODIMENTS

Preferred embodiments will now be described with reference to the drawings. To facilitate description, any element numeral representing an, element in one figure will be used to represent the same element when used in any other figure. While the preferred embodiments are described below with reference to a ditherer used in a high speed imaging scanner, a practitioner in the art will recognize the principles described herein are viable to other applications.

The method and system using a ditherer for optical scanning, as described in this disclosure, may also apply to a system as disclosed in U.S. application Ser. No. 11/045,214, and is hereby incorporated by reference.

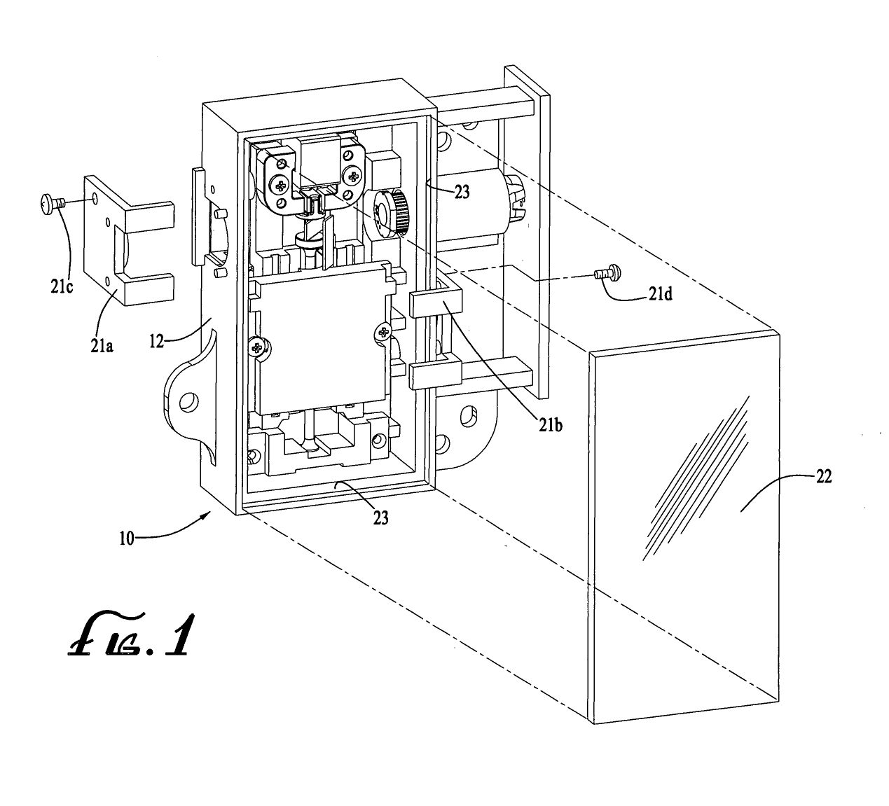

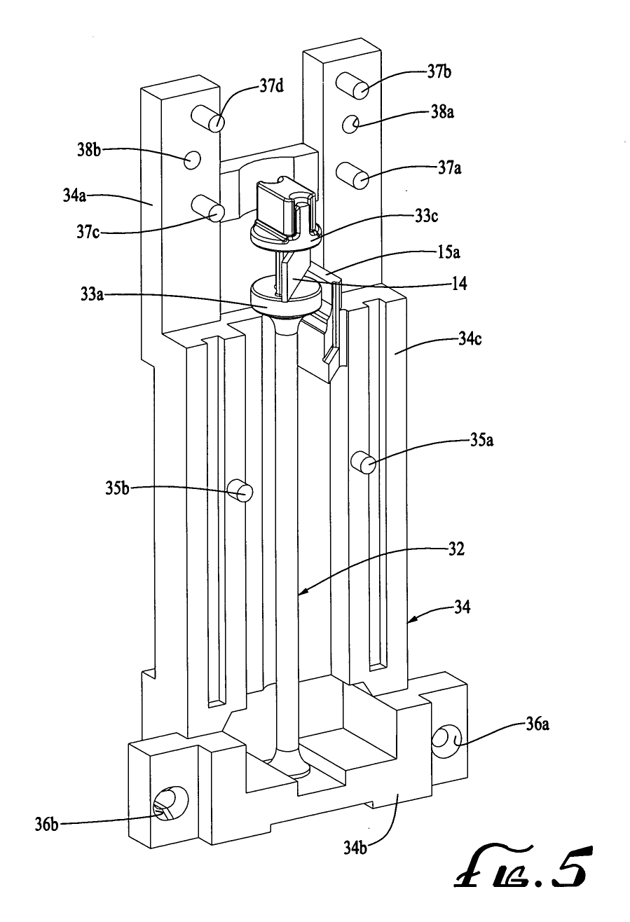

FIGS. 1-8 illustrate a high speed torsional dither assembly 10 having a dither mount assembly 34 contained inside a soundproof enclosure comprised of a box 12 and a transparent lid 22. The lid 22 may be made of any suitable transparent material such as glass or plastic and is installed into a recess 23 on the front side of the box 12. The lid 22 is secured in place via “L” brackets 21a, 21b which are securely held in place via posts 19a, 19b and screws 21c, 21d. Bracket 21a is shown in an exploded view in FIG. 1, in position to moved onto the posts 19a with the bracket fingers securing the lid 22 in place. The other bracket 21b is show in FIG. 1 in the installed position on posts 19b. Alternately, the lid 22 may comprise an opaque material (e.g. plastic or metal) and a central window of transparent material through which the scanning beam off mirror 14 may pass. The dither mount assembly 34 is suspended inside the box 12 by an elastomeric support assembly 30 that preferably limits the transmission of sound from the dither assembly to the enclosure. The dither mount assembly 34 further comprises a dither arm 32 (in the form of a torsion rod assembly) and electromagnet circuit fastened to the dither mount 34. The electromagnetic circuit may be composed of a laminated steel core 16 (the core preferably being fabricated in two pieces 16a and 16b facilitating assembly) and a coil 18. The dither arm 32 includes a base 32b, a shaft 32c and a top piece 32d wherein the top piece 32d is attached to a top mirror and magnet mount section 33. The dither mount base 34b is formed with a hole for accepting the dither arm base 32b. The dither arm base 32b may be inserted into the hole and then secured in place by welding or other suitable method.

To allow torque to be generated on the dither arm by current in the coil 18, the magnet 20 is positioned within the electromagnetic field of the laminated core 16. A driver circuit 100, located on PCB 28, is connected to the coil 18 to provide oscillating current to the coil that in turn generates a torque on the dither arm 32. In addition, the driver circuit may sense the motion via induced voltage or emf generated by the magnet moving within the magnetic field of the electromagnetic circuit.

A laser diode module 27, comprising a visible laser diode 26 and focusing lens 24, is located inside the enclosure 12. The laser diode module 27 emits a laser beam toward the mirror 14 and reflected light from the mirror 14 on the dither arm 32 generates an oscillating beam of light (i.e., a scan line) as the dither arm oscillates.

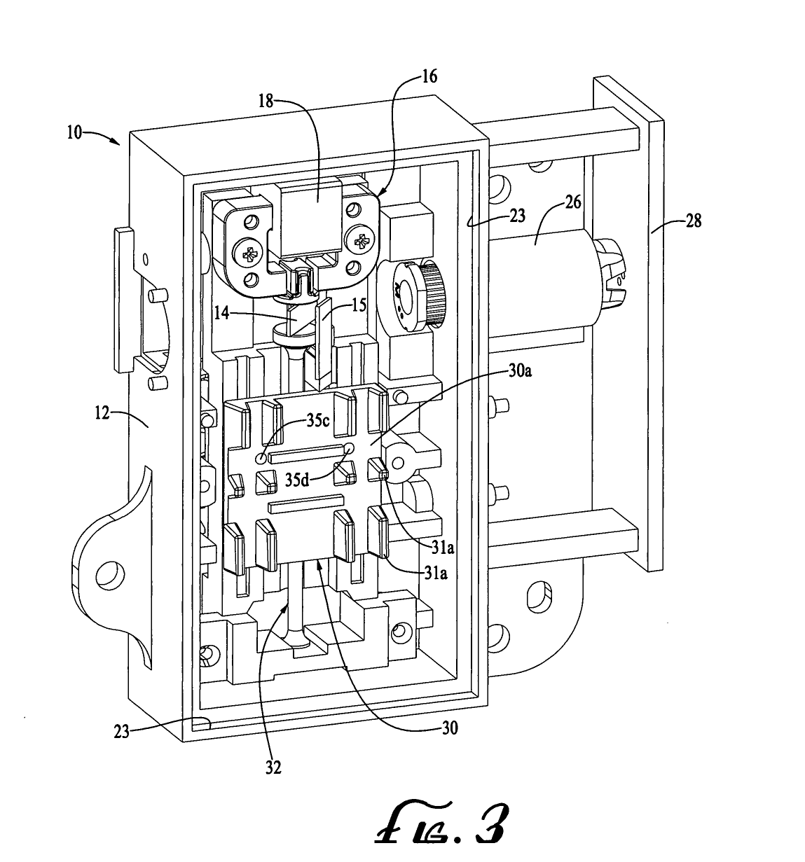

Referring to FIGS. 3-4, the elastomeric supports 30 are constructed in two pieces—a top or front mount piece 30a on the top/front side of the dither mount 34 and a bottom or rear mount piece 30b on the bottom/rear of the dither mount 34. The mount pieces 30a, 30b have several cones 31a, 31b that protrude from the dither mount. The cones 31b from the bottom support 30b contact the box 12, while the cones 31a from the top support 30a contact the mount restraining piece 29. The shape of these cones, by limiting the surface area of contact with box 12 and restraining piece 29, allow the dither mount assembly 34 to vibrate at a low frequency, due to the low stiffness of the elastomeric supports. This arrangement limits the high frequency noise transmission from the dither mount assembly 34 to the walls of box 12. The wide spacing of the cones improves the mechanical registration of the dither mount assembly 34 to the box 12, to ensure that the laser diode module is properly aligned with the mirror 14 thereby ensuring that the laser beam hits the mirror 14.

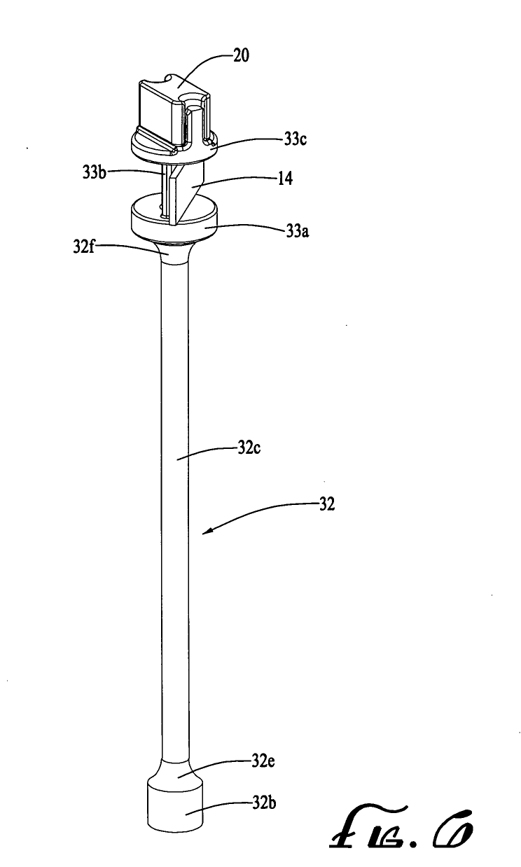

One embodiment of the dither arm 32 is shown in more detail in FIGS. 4-8. In this design, dither arm 32 is fabricated in several pieces. As best shown in FIG. 8, the shaft piece 32a is preferably integrally formed in a single piece by machining from a wire stock having good fatigue characteristics. Shaft piece 32a has a central section 32c of smaller diameter and mounting ends 32b and 32d with fillets 32e, 32f that transition into the shaft region 32c. These features can be preferably created using rolling techniques. This manufacturing technique creates a shaft piece 32a having a smooth central shaft region 32c that is highly polished to ensure good fatigue characteristics (i.e. long life). The fillet regions 32e, 32f promote a reduction in stress toward the attachment points to end pieces 32b and 32d.

As best viewed in FIGS. 7-8, a mounting piece 33 is attached to the top (free) end piece 32d of the shaft section 32a, such as via welding. The bottom of the first section 33a may include a cavity 33e for accepting the end piece 32d. Once in place within the cavity 33e, the end piece 32d may be secured in place such as by welding or other suitable method. The mounting piece 33 includes a first section 33a, a central mirror mount section 33b and a top magnet mount section 33c. The mounting piece 33 may be formed as a cast part, preferably from the same material as the shaft section 32a. The top magnet mount section 33c includes upwardly extending posts 33d, 33d. The magnet 20 is formed with lateral indentations such that the magnet is securely positioned between the posts, with the posts disposed in the lateral indentations.

This construction of the dither arm 32 produces a rigid structure that promotes a high Q of oscillation, that is, an oscillation of significant magnitude with only a small loss of energy per cycle, known as low damping. This low damping improves the efficiency of the dither device and promotes long life, as high damping is often a sign of material fatigue. A properly designed dither arm may have a Q on the order of 800. Q is typically calculated as the ratio of the resonant frequency fₒ. divided by the difference in frequency where the oscillation is at 70% of maximum amplitude Δf, as in Q=fₒ/Δf.

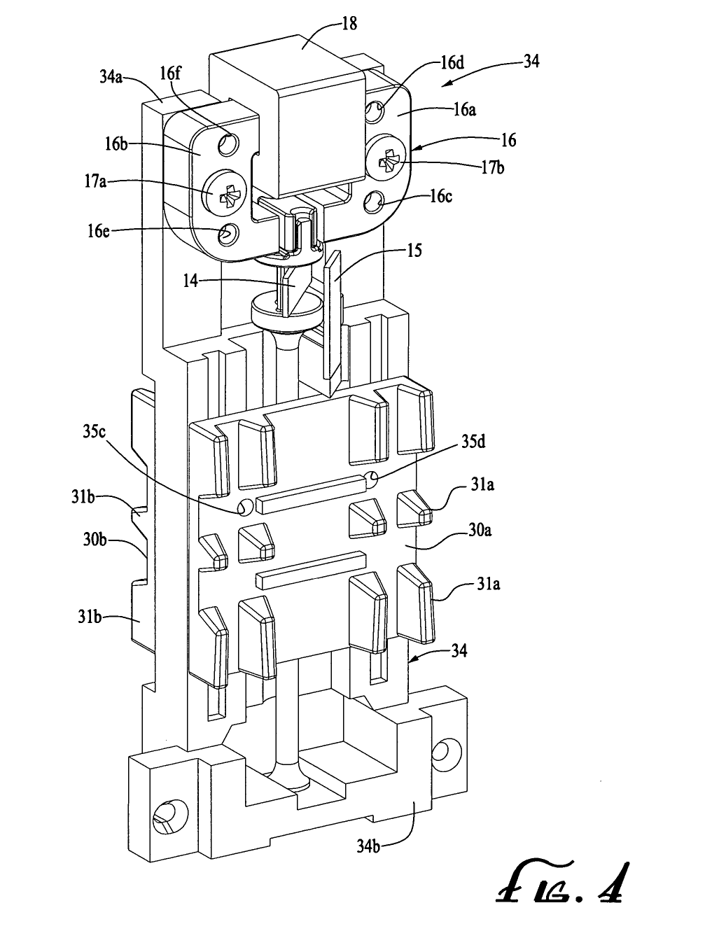

The dither arm 32 with the top section 33 and magnet 20 is inserted into the dither mount assembly 34, with the lower section 32b of the dither arm inserted into the hole in the dither mount base 34b and then secured in place by welding or other suitable method. The dither mount assembly 34 includes a central section 34c with alignment posts 35a, 35b (shown in FIG. 5). The front mount piece 30a has corresponding holes 35c, 35d (as shown in FIG. 3) which engage the posts 35a, 35b for holding the front mount piece 30a in place during assembly. The rear mount piece 30b includes a similar alignment scheme.

The steel core 16 and electromagnet 18 assembly is then installed on the upper section 34a of the dither mount. The upper dither mount section 34a includes four alignment posts 37a, 37b, 37c, 37d and threaded holes 38a, 38b (shown in FIG. 5). The core 16 has corresponding holes 16c, 16d, 16e, 16f (as shown in FIG. 4) that engage the posts 37a, 37b, 37c, 37d for holding the front mount piece 30a in place during assembly and operation. Screws 17a, 17b lock the core 16 in place and in combination with the posts results in a secure attachment scheme.

The dither mount 34 with the core 16 and magnet 18 in place (from FIG. 4) is then inserted into the box 12 (see the position as in FIG. 3). The lower dither mount includes alignment holes 36a, 36b that are used in combination with alignment posts (from a fixture, not shown) to align the dither mount in position within the box 12. Once in position, the mount restraining piece 29 is installed, attached by the screws 29a, 29b. Once secured, the alignment posts are removed from the alignment holes 36a, 36b so that the entire dithering assembly is vibrationally isolated from the walls of the box 12 and supported entirely via the elastomeric mounting pieces 30a, 30b.

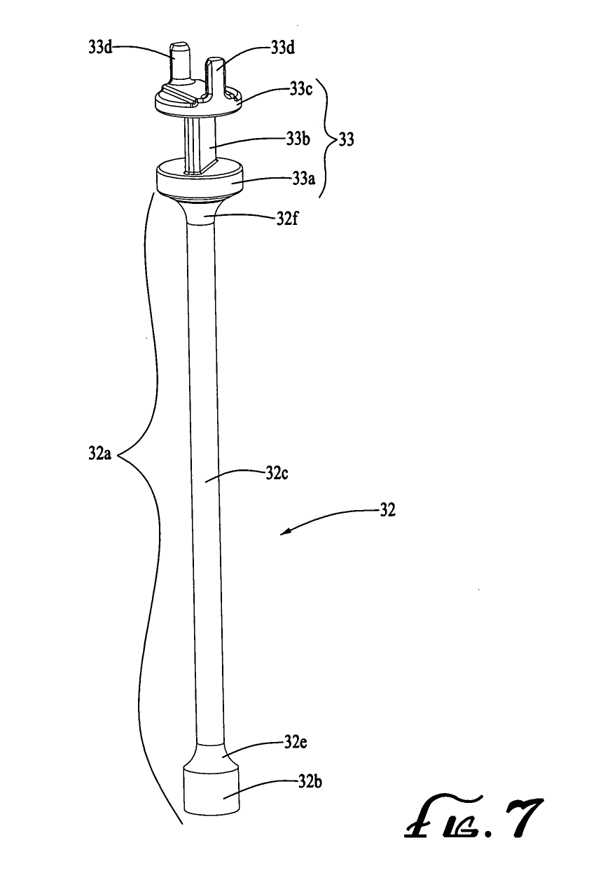

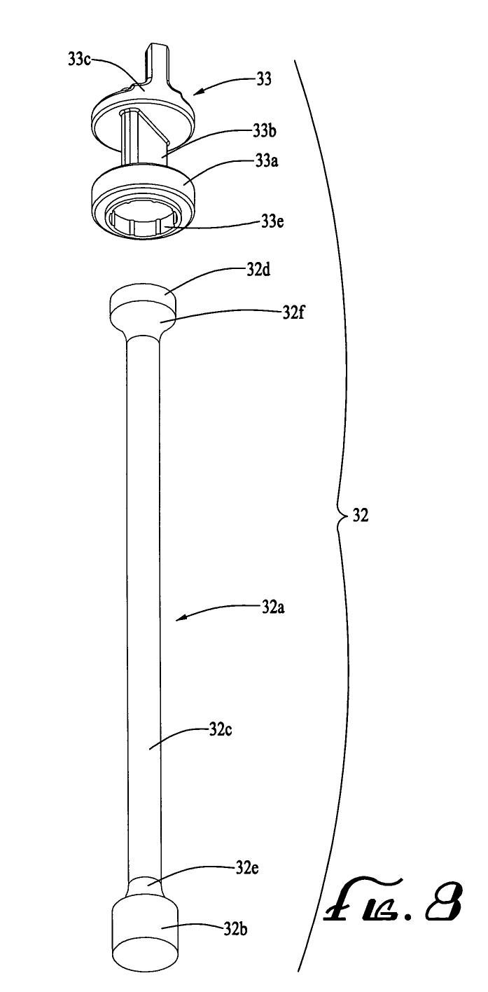

FIGS. 9-10 illustrate an alternate embodiment for a dither assembly 134. In one construction, the entire dither arm assembly 132 illustrated in FIG. 9 is machined from a single piece of wire stock. Alternately the part may be cast, but the machined construction provides a finished product with superior strength and durability with fewer defects. The dither arm 132 includes a central section or shaft 132a having the narrowest diameter which acts as a torsional dither spring (or torsion rod) and is thus preferably highly polished and without defects in order to achieve good fatigue characteristics. The spring motion or characteristic is due to twisting or torsional motion. Preferably the connection between the central shaft 132a and the bottom end 132b is formed with a gradual transition or fillet. The dither arm 132 is formed with a top plate 132c, mirror bracket 132d, and magnet mount 132e. The magnet mount 132e includes post 132f, 132f for accepting the magnet 20. Preferably the connection between the central shaft and the top piece 132c is formed with a gradual transition or fillet. As in the previous, this gradual transition or fillet provides a greater stiffness and strength at the transition thus moving the greatest torsional deflection of the dither arm toward the center bf the central portion 1 32a.

The bottom or fixed end 132b of the dither arm 132 is formed in an enlarged disk-shaped structure. The disk-shaped structure is generally round but has flat lateral sides 132b. The bottom end 132b of the dither arm 132 fits into a corresponding hole 135 in the base 134b of the dither assembly 134 with the flat lateral sides preventing rotation. Once in place, the bottom end 132b is secured by a bracket 136 that in turn is attached by screws 137a, 137b that engage threaded holes in the base 134b. The remaining elements of the dither assembly 134 are the same as the corresponding elements of the embodiment of FIGS. 1-5. The steel core 16 and electro-magnet assembly 18 is installed on the upper section 134a of the dither mount. The mirror 114 is installed on the mirror mount 132d. The dither 134 may then be installed in the box 12 of the embodiment of FIG. 1, being mounted via front and rear mount pieces 30a and 30b (of elastomeric material) that provide the desired vibrational isolation.

The dither arm 32 (or the alternate dither arm 132) is driven into oscillation by the action of an oscillating magnetic field upon magnet 20. The central section 32c of the dither arm 32 acts a torsion bar or spring, torsionally twisting to provide the oscillating motion for the mirror 14. Preferably, the torsion rod does not flex laterally and thus maintains a straight longitudinal axis. The upper portion of the dithering assembly (e.g. the magnet 20 and magnet mount 33c) may be surrounded on multiple lateral sides by the electro-magnet 16 or stops (separated by gaps providing adequate clearance for the rotational oscillation) such that during a shock event the torsion bar is not overflexed/damaged.

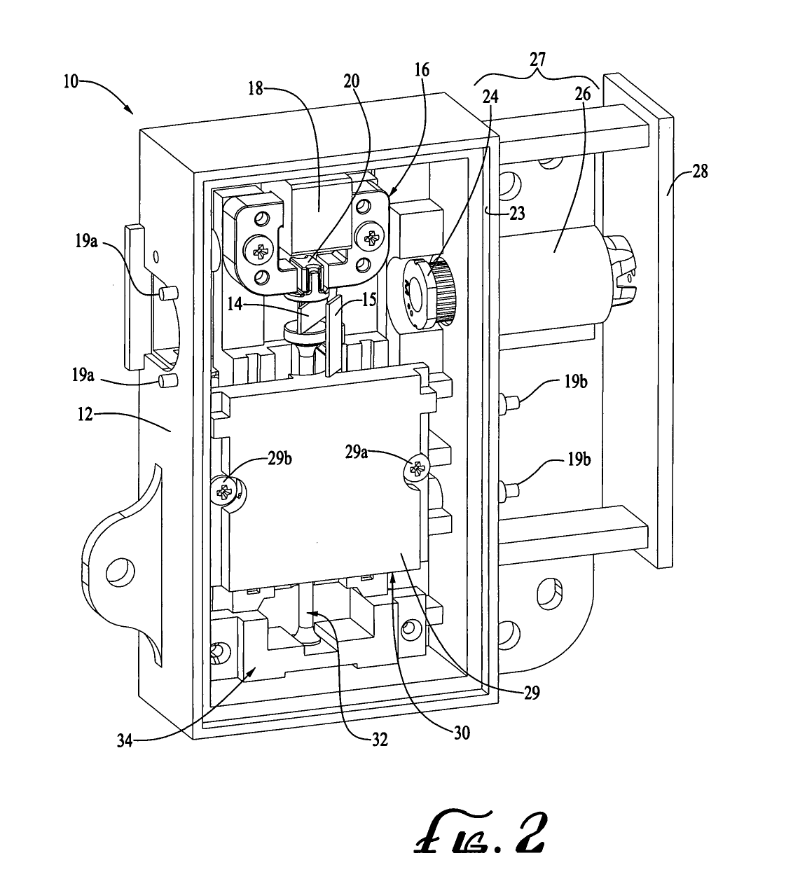

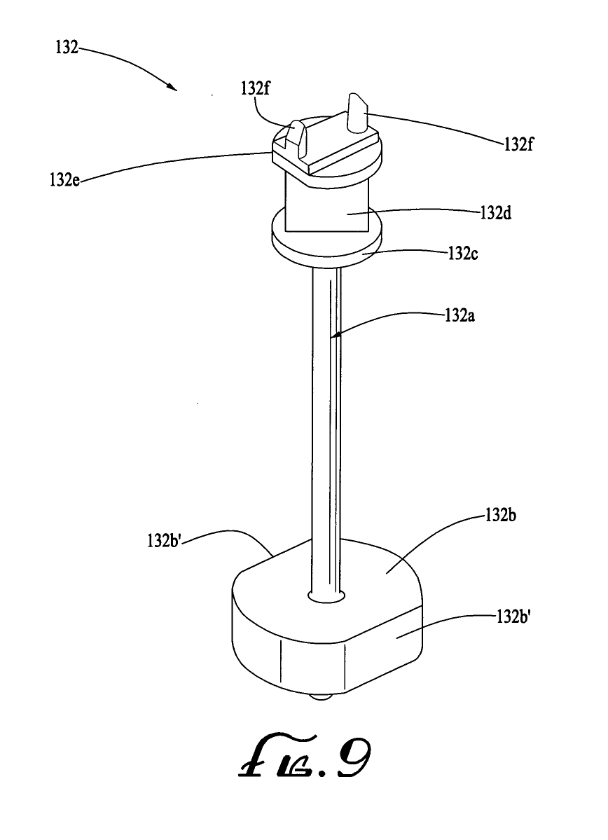

The oscillating magnetic field is created from current in coil 18 causing a magnetic flux to be generated in the laminated steel core 16 forming a directed flux across the air gap between cores 16a and 16b through the magnet 20, as shown in FIG. 2. Operation of this magnetic circuit can be more easily seen from a simplified top view in FIG. 11 and a simplified side view in the diagram of FIG. 12, showing only the electromagnetic components. FIG. 11 illustrates the magnetic flux from coil 18 traversing through steel cores 16a and 16b. The flux traverses the air gaps 52a and 52b and goes past magnet 20 to complete the magnetic circuit. The flux of the magnet 20 is top to bottom in FIG. 11, while the flux from the steel core is left to right in FIG. 11. This magnetic field causes a counter-clockwise torque 50a upon the magnet 20. It is understood that current in coil 18 is of alternating sign (an AC current), so the flux direction and thus torque on magnet 20 reverses at the drive frequency. The torque on the magnet 20 from the magnetic flux generated by the coil 18 is applied to the dither arm 32. The applied torques causes rotation about the fixed mount 34b. Torque is proportional to the amplitude of the magnetic field that is generated by the magnet. This field strength can be increased by making the top piece 33c out of a magnetically permeable material such as steel. In this case, a closed magnetic circuit is achieved with magnet 20, steel posts 33d, and steel top piece 33c, greatly increasing the magnetic field strength. As the mechanical Q of the dither arm is very high, the drive frequency of the coil current must very closely match the resonant frequency of the dither arm. When this close matching is achieved, the angular deflection of the top of the dither arm 32a will be large, yielding a large oscillating deflection of the dither mirror 14 using a minimal expenditure of power. Light from the laser diode module 27 bounces off mirror 14 creating an oscillating scan line.

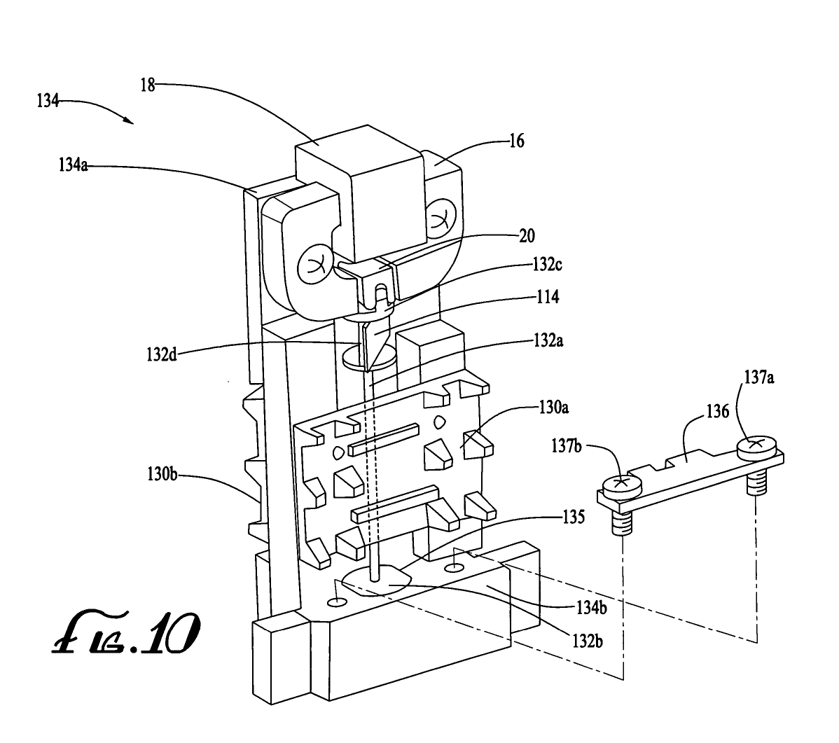

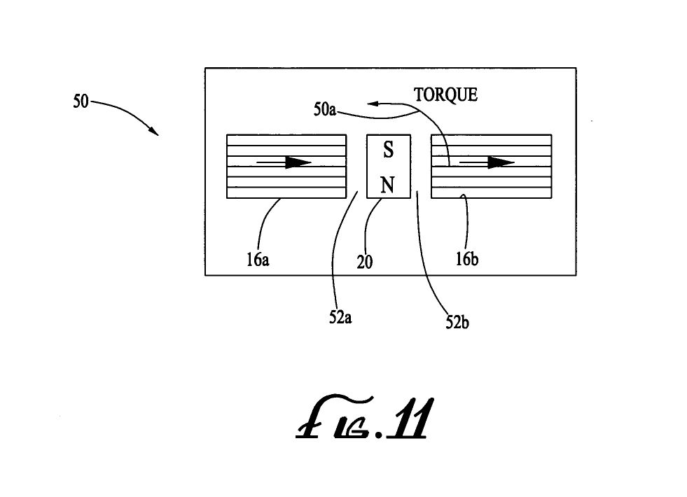

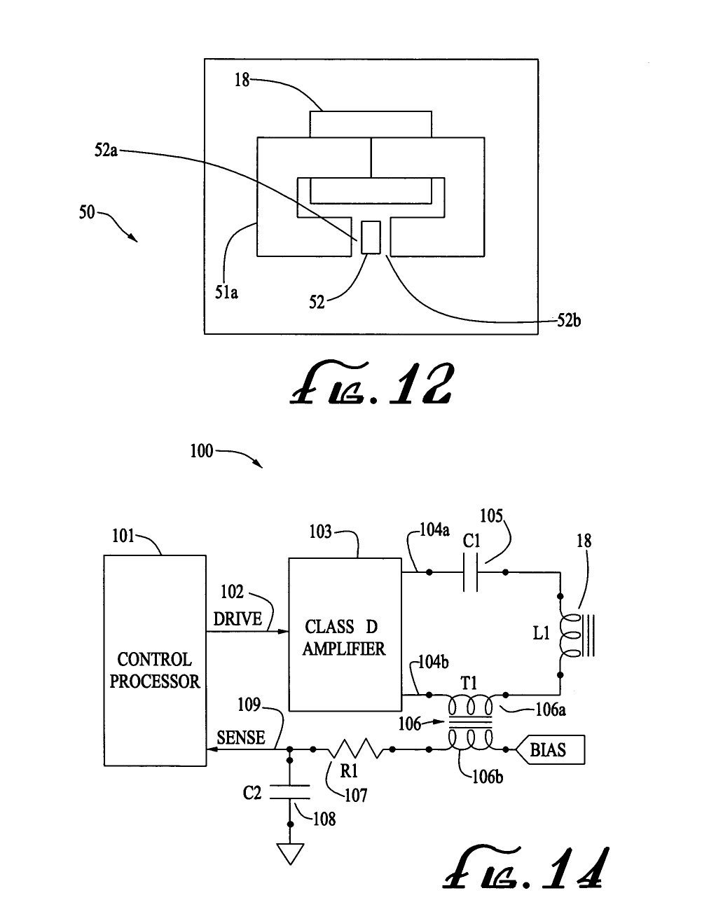

FIGS. 13A-13D diagrammatically illustrate the deflection operation of a laser beam off a scanning mirror 14. FIG. 13A illustrates that incoming light 82 impinges on the scan mirror 14 at an angle α to the vertical and outgoing light is reflected off the mirror 14 at the same angle α to the vertical. When the scan mirror 14 is rotated by an angle θ as shown in FIG. 13B, the laser beam bouncing off the mirror 14 will have an angular deflection/rotation of 2.θ. Thus the optical deflection off the mirror is twice the physical deflection of the mirror. The actual deflection of the torsion rod (from rest) is only +/− 1/2·θ in order to achieve a total physical deflection of θ.

In another embodiment, the system may alternately be configured such that the laser light undergoes two bounces off of mirror 14. In this alternate embodiment, a secondary stationary mirror 15 is disposed on mounting bracket 15a located nearby and parallel to oscillating mirror 14. The mirror 15 is used to reflect light from the first bounce off of mirror 14 back onto the mirror 14. FIG. 13C illustrates that incoming light 84 impinges on the scan mirror 14 at an angle a to the vertical is reflected at the same angle α. As the mirror 14 is pivoted as shown in FIG. 13D, light from the second bounce from mirror 14 is emitted as the oscillating scan line. For a given angular deflection θ of the top of the dither arm 32, the laser beam after first bouncing off of mirror 14 will have an angular deflection of 2·θ. If two bounces off of mirror 14 are achieved, the laser beam (scan line) will have an angular deflection of 4·θ. Thus in the double bounce configuration, the optical deflection off the mirror is four times the physical deflection of the mirror and twice as great in the two bounce case as in the single bounce case. Thus, a smaller mechanical deflection angle θ (i.e.+/− 1/2·θ) can be used to create a desired optical deflection. This smaller deflection may result in significantly lower electrical power consumption, increased mechanical life due to lower levels of stress on the dither shaft 32a and lower noise due to a smaller physical excursion of dither mirror 14. A disadvantage is the tighter mechanical tolerances required to obtain two bounces off of dither mirror 14.

The system may be alternately provided with a second pivoting mirror in combination with the primary mirror 14 to create a two-dimensional pattern. One example may comprise mounting the secondary mirror 15 on an oscillating mirror bracket 15a that pivots in a plane disposed 90° to the pivot plane of the primary mirror 14. Alternately, an inline pivoting mirror mechanism such as disclosed in U.S. Pat. No. 6,585,161 (hereby incorporated by reference), may be disposed between the primary mirror 14 and the light source 26 to provide a second scan dimension. The pivoting speed of the secondary mirror will likely be much lower than that of the primary mirror 14 and may be provided by a more conventional scan motor configuration such as a servo motor.

The design for the dither arm is intended to provide a highly robust construction. As described below, this dither arm is expected to be driven at high speed, on the order of about 5KHz. A preferred range is between about 4KHz and 8KHz. With an intended product life of at least five years, such a dither arm would undergo about 788 billion cycles (calculated by: 5 years × 365 days/year x 24 hours/day × 60 min/hour × 60 sec/min × 5000 cycles/sec). Thus it may be expected that such a construction should have a life of on the order of 1 trillion cycles.

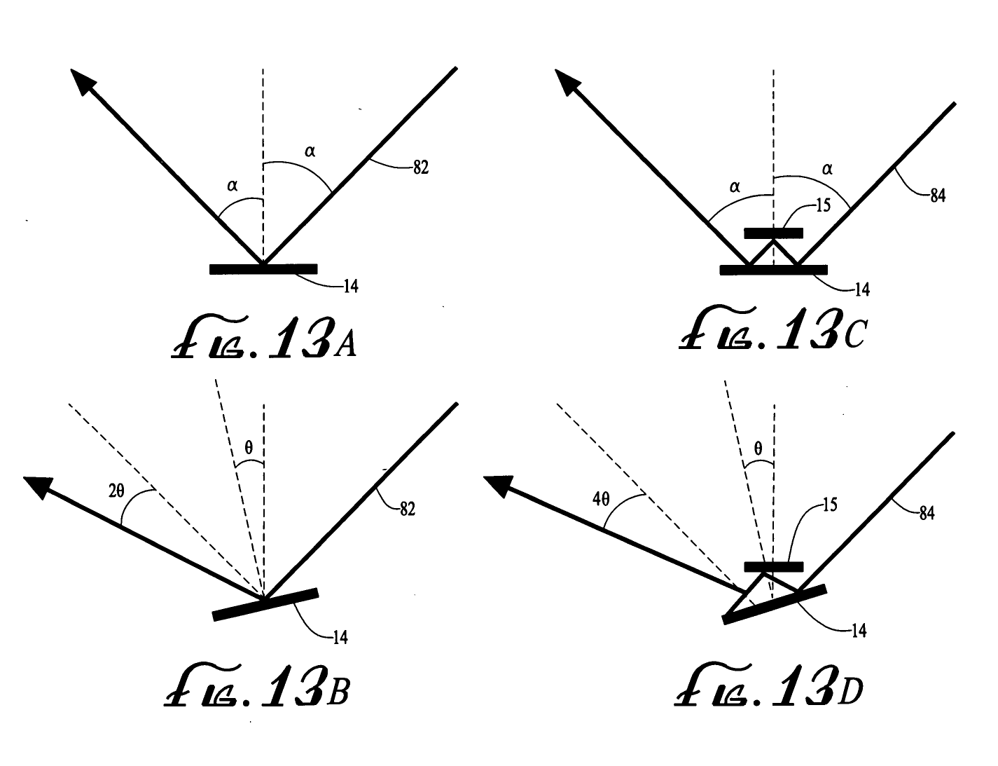

FIG. 14 is a diagram of a closed loop control circuit 100 for detecting the relative rotational position of the top end 33 of the dither arm 32 and providing appropriate current into coil 18 to drive the dither arm 32 at mechanical resonance with the desired mechanical deflection θ. The control circuit 100 comprises a control processor 101 generating a drive signal 102 that may be sinusoidal at a frequency f. The drive signal 102 is an input to amplifier 103, which is preferably a class D amplifier in order to achieve high electrical efficiency. Class D amplifiers generate a pair of bipolar complementary binary outputs, shown as signals 104a and 104b in FIG. 14. The binary outputs are modulated at a high frequency, such as 100 KHz, while the duty cycle of these outputs is modulated such that the low frequency behavior of the outputs sufficiently matches the input signal 102. This modulation allows the amplifier 103 to drive the outputs 104 either high or low via low impedance switches internal to the amplifier, avoiding excursion into the linear region between the supply rails while yielding very high electrical efficiency. The output of amplifier 103 drives the dither coil 18. Inductance of this coil, especially with the inclusion of the steel core 16 is quite high at the high frequency of operation, which may be on the order of 5 KHz for a suitably designed high speed ditherer. This high inductance inhibits efficient drive of the coil by a low voltage amplifier. Since the ditherer is intended to be driven only at a narrow range of frequencies closely surrounding the mechanical resonance of the device, the electrical efficiency of the drive circuit 100 can be greatly improved by making the load of amplifier 103 electrically resonant as well. The inclusion of capacitor 105 in the circuit 100 creates a series resonant circuit with coil 18. Proper selection of capacitor 105 yields a load where the capacitive reactance at the drive frequency f nearly exactly counteracts the inductive reactance of coil 18, yielding a very low effective impedance that is due to the series resistance of coil 18 and the leakage resistance due to eddy current loss in the steel core 16. This low impedance is efficiently driven by amplifier 103 with a tolerably low voltage, such as 5 V.

In order to drive the dither arm 32 at mechanical resonance, the position of the magnet 20 must be monitored. As the magnet 20 is oscillating in the magnetic field between cores 16a and 16b, it disrupts this field, generating a back EMF in coil 18, proportional to the speed of oscillation of the magnet 20 in this field. This change in voltage on coil 18 can be sensed as a change in current from amplifier 103, as the amplifier drives the load at a constant voltage. As the output of the amplifier 103 is a pair of pulse width modulated square waves, sensing of current can be difficult. Current sensing is made practical by use of current transformer 106. Current in the primary leg 106a of transformer 106 creates magnetic flux in the transformer. Change in current in the primary leg 106a results in a voltage waveform in secondary leg 106b. Biasing of one end of the secondary leg 106b with a bias voltage midway between the supply voltage rails, such as at 2.5 V, allows the output of the secondary leg 106b to yield a sine wave voltage proportional to the velocity of the magnet 20, yet suitably offset to stay within the supply voltage rails. There may still be significant ripple in this output caused by the high frequency pulse modulated output from amplifier 103. The low pass filtering effect of resistor 107 and capacitor 108 may reduce this ripple. The smoothed sense signal is thus presented to control processor 101 via signal 109.

Control processor 101 uses the sense signal 109 in order to create a drive signal 102 that has the correct frequency, amplitude, and phase to drive the dither arm 32 at mechanical resonance at the desired deflection angle θ. While those skilled in the art of control theory can conceive of many practical methods to achieve this, the preferred embodiment is the following. Control processor 101 can generate a mathematical model of the amplifier 103, load circuit 105,18, and 106a, and sense circuit 106b, 107, and 108 (called the network response) by injecting a waveform into the amplifier 103 via drive signal 102 and sensing the result on sense line 109. A suitable waveform is a summation of several sine waves that bracket the mechanical resonant frequency but do not include it. Such a wideband source can be used to measure the network response and null it by use of an adaptive filter. Specifically, the output waveform is generated and an adaptive filter is adapted (i.e. matching or training) using signal 109 as input until its output matches the drive signal 102. By staying away from the mechanical resonant frequency, only the electrical characteristics of the network response are sensed. Once this matching has been completed, a sine sweep can commence at frequencies near the expected mechanical resonance of the dither arm 32. The sense signal 109 will include effects of the network response plus that of the back EMF from the mechanical motion of the dither arm 32. Typically the back EMF signal is quite a bit smaller than the network response. The output of the previously trained adaptive filter is subtracted from sense signal 109, yielding a signal that contains only the back EMF signal due to mechanical motion. Control theory techniques can be used to adjust the frequency of the drive signal 102 until the desired amplitude is achieved. These techniques include adjustment of frequency to minimize phase differences between the drive and back EMF signal that occur at mechanical resonance. The dither arm may be driven at exact mechanical resonance and the output of the drive signal 102 adjusted to achieve the desired deflection angle θ, or more preferably the amplitude may be held constant while the frequency is slightly adjusted off of mechanical resonance to achieve the desired deflection angle θ. The control circuit 100 may be placed on circuit board 28 (see FIG. 1) along with the drive circuit for the laser assembly 27 yielding a compact package.

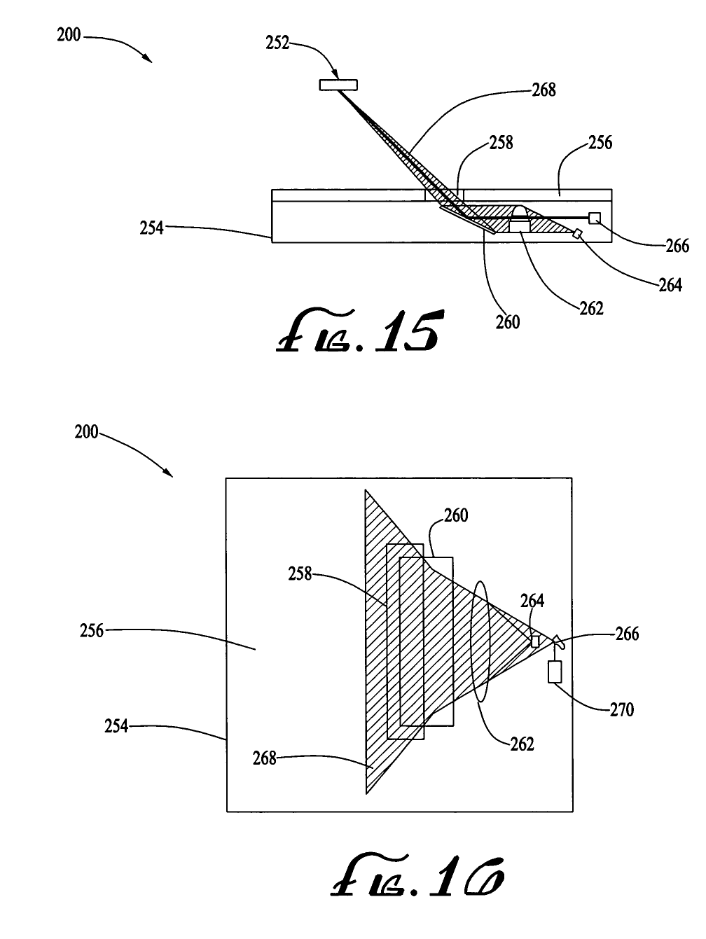

FIGS. 15-16 illustrate a preferred embodiment for a single line imaging system using the components of the high speed dithering assembly 10 of FIGS. 1-8. FIG. 15 is a side view of a single line non-retrodirective collection mechanism 200, and FIG. 16 is a top plan view thereof. The non-retrodirective collection mechanism 200 includes a housing 254 with a window 258 embedded into a horizontal surface 256. The illumination source 270 (preferably a visible laser diode module) and deflection mirror 266 are components of the high speed dither assembly 10 of FIG. 1. The oscillating scan line generated from this mechanism passes through a slot in collection lens 262, off a beam redirection mirror 260, and then up through the window 258 into the scan region. The light reflected from an object 252 passes through the window 258 onto the beam redirection mirror 260, and is focused by the collection lens 262 onto the detector 264. The beam redirection mirror 260 aligns the scanning mechanism parallel to the horizontal plane creating a slim profile.

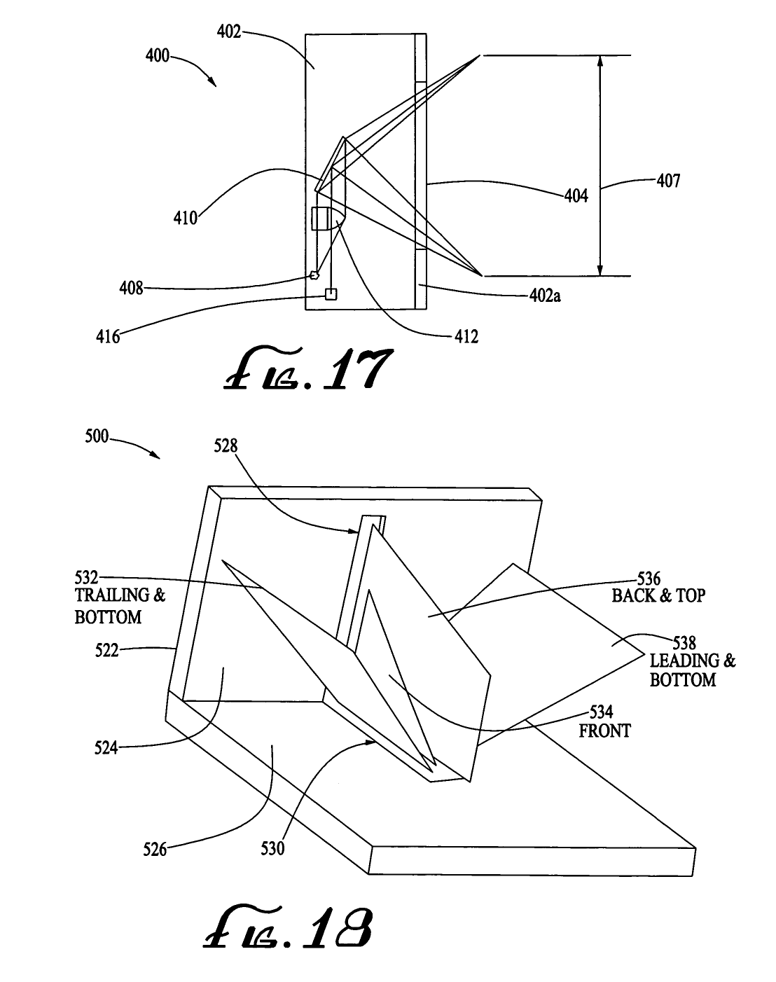

The motion of object 252 across the laser scan line allows a 2-D raster image of the object to be captured with detector 264. Additionally, multiple mechanisms 200 may be used to image multiple sides of an object at once. FIG. 17 illustrates an imaging system 400 capable of capturing a 2-D image of a stationary or slowly moving object (as opposed to the system 200 which captures 2-D images of moving objects only). A high speed single line imaging system, similar to system 200 of FIG. 15, is shown including a laser source (not shown), a dither mirror 416, a collection lens 412, and a detector 408 that is aligned toward deflection mirror 410. The deflection mirror 410 corresponds in function to mirror 260 of FIG. 15. The deflection mirror 410 is rotated or dithered at a slow speed in order to direct the laser scan line from the high speed ditherer mechanism toward different portions of the field of view 407. As the deflection mirror 410 is dithered back and forth, two complete images can be captured for each full oscillation of the deflection mirror 410. Assuming a frequency of oscillation of deflection mirror 410 of 5Hz, then the frame rate of captured images would be 10Hz. In a similar fashion, since the high speed ditherer oscillates the deflection mirror 14 back and forth, two complete scans of an object can be captured for each full oscillation of the deflection mirror 14, which sets the line rate of image capture. It is desirable for the line rate f₂ to be an integer multiple of the frame rate f₁ yielding a relationship f₂ = M × f₁ where f₂ is the line rate, M is an integer and f₁ is the frame rate. Similarly, the data captured from the detector 264 should be digitized at a rate that is an integer multiple of the line rate. The frequency of signal digitization is termed the pixel clock, f₃, so f₃ = N × f₂, where f₂ is the line rate and N is an integer. Thus, images of a resolution of N × M are captured at a rate of f₁ frames per second by the imaging system of FIG. 12. As a typical example, with deflection mirror 410 oscillating at 5Hz, corresponding to f₁ = 10Hz, and deflection mirror 14 oscillating at 5KHz, corresponding to f₂ = 10KHz, and a pixel clock of f₃ = 10MHz, yields an image of N= 1000 by M= 1000 pixels per frame at a frame rate of 10Hz, or 10 frames per second. An appropriate projected pixel size for reading 10mil barcodes would be 5mils by 5mils, which allows for 2 digitized pixels per minimum bar size. The imaging system of FIG. 17 would then be able to image an area of 5 inches by 5 inches. At the frame rate of 10 frames per second, a barcode label could be captured by this system even if traveling at a speed of up to 50 inches per second.

FIG. 18 illustrates an L-scanner 500 that is a combination of a vertical component and a horizontal component that is capable of high speed multi-plane imaging. This device 500 may be used to image barcodes from various points of view, enabling capture of an image of a barcode on an object regardless of its orientation. Processing of these images by a suitable processing system may produce a barcode reading device with high performance. In a preferred configuration, the L-scanner 500 comprises four high speed scan mechanisms, each generating a high speed scan line in order to provide multi-sided capturing of images. Assuming a right to left motion of the object to be scanned, the four scan lines include a leading and bottom line 538, a back and top line 536, a front line 534 and a trailing and bottom line 532. The L-scanner 500 includes a housing 522 with a (vertical) first window 528 disposed on the first vertical portion 524 of the housing 522 and a second window 530 disposed on the second horizontal portion 526 of the housing 522. The back and top scan line 536 is imaged through the first (vertical) window 528. The leading and bottom scan line 538, the front scan line 534 and the trailing and bottom scan line 532 are imaged through the second (horizontal) window 530. These scan lines provide a full 2-D image of any object sweeping across the imager yielding omnidirectional barcode reading and imaging along each line. Using different scan generators provides imaging of multiple sides on an object that may be obscured from view. Additional scan lines may also be generated through the vertical window 528 to provide enhanced scan coverage. For example, two additional scan lines, similar to lines 532, 538 of the horizontal, may be passed through window 528. These additional scan lines may be also used instead of scan lines 532 and 538 as the application requires. Further details of multiple image systems are described in U.S. patent application Ser. No. 11/279,365, filed Apr. 11, 2006 by Bryan Olmstead hereby incorporated by reference.

While there has been illustrated and described a disclosure with reference to certain embodiment, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. A laser scan module comprising
a dithering assembly including
a base;
a torsion rod with a longitudinal axis and having a fixed end secured to the base and a free end,
a magnet and mirror assembly mounted to the free end of the torsion rod, the mount section including a mirror mount and a magnet mount,
a scan mirror mounted to the mirror mount,
a magnet mounted to the magnet mount;
an electromagnetic drive for driving the magnet and oscillating the free end of the torsion rod about the longitudinal axis of the torsion rod.

2. A laser scan module according to claim 1 further comprising a drive circuit for driving the dithering assembly at resonance.

3. A laser scan module according to claim 1 wherein the torsion rod is integrally formed in a single piece from wire stock that is machined to form a central shaft section, an enlarged fixed end and an enlarged free end.

4. A laser scan module according to claim 3 wherein the torsion rod is further formed with fillets between the central shaft section and respective fixed end and free end to provide for gradual transition therebetween.

5. A laser scan module according to claim 3 wherein the magnet and mirror assembly is integrally formed with the torsion rod via machining of the wire stock.

6. A laser scan module according to claim 3 wherein the magnet and mirror assembly comprises a cast part comprising the mirror mount and the magnet mount.

7. A laser scan module according to claim 6 wherein the cast part is welded to the free end of the torsion rod.

8. A laser scan module according to claim 1 further comprising an outer enclosure, wherein the base of the dithering assembly is suspended inside the enclosure and vibrationally isolated therefrom via elastomeric supports.

9. A laser scan module comprising a dithering assembly having:
a base;
a torsion rod integrally formed in a single piece by machining from a solid metal piece, the torsion rod including a first end connected to the base and a second end opposite the first end;
a mount section attached to second end of the torsion rod.

10. A laser scan module according to claim 9 wherein the mount section comprises a cast part welded to the torsion rod.

11. A laser scan module according to claim 10 wherein the mount section comprises a mirror mount and a magnet mount, with a scan mirror is mounted to the mirror mount and a magnet mounted to the magnet mount.

12. A laser scan module according to claim 11 further comprising
an electromagnetic drive for driving the magnet and oscillating the free end of the torsion rod about the longitudinal axis of the torsion rod.

13. A laser scan module according to claim 9 wherein the solid metal piece comprises wire stock.

14. A laser scan module according to claim 9 wherein the mount section is formed with the torsion rod as a single machined piece therewith.

15. A laser scanning system comprising
a scanning assembly including a scan mirror and a mirror drive for scanning the scan mirror over a scan angle;
a laser beam source generating a laser beam and directing the laser beam onto the scan mirror;
a fixed secondary scan mirror positioned proximate to and facing the scan mirror,
wherein the laser beam is directed in sequence (1) onto the scan mirror, (2) off the scan mirror to the fixed secondary scan mirror, (3) off the fixed secondary scan mirror and back onto the scan mirror, (4) off the scan mirror and out into a scan volume.

16. A laser scanning system according to claim 15 further comprising
a second scan mirror disposed downstream of the scanning assembly for producing a two-dimensional scan pattern.

17. A scanning system comprising
a dither arm having a free and a fixed end;
a scan mirror and magnet mounted onto the free end of the dither arm;
an electromagnetic drive coil for driving the scan mirror;
a controller driver circuit connected to the drive coil to provide an oscillating signal to the drive coil for generating a drive torque on the dither arm, wherein the driver circuit senses motion of the scan mirror via induced voltage or back emf generated by the magnet moving within a magnetic field of the electromagnetic drive coil.

18. A system according to claim 17 wherein the controller driver circuit includes an adaptive filter trained to match sensed current on the drive coil given the oscillating drive signal as an input.

19. A system according to claim 18 wherein the controller drive circuit uses the adaptive filter to null out the drive signal from a total voltage signal on the drive coil to determine the induced voltage or back emf due to the moving magnet.

20. A method of controlling an electromagnetic drive coil to drive an oscillating scanner component in alternate circumferential directions between first and second scan end positions, comprising the steps of
generating a periodic drive signal to drive an electromagnetic drive coil;
determining total impedance on the electromagnetic drive coil;
determining motion impedance in the electromagnetic drive coil by filtering out coil impedance from the total impedance;
adjusting frequency of the drive signal applied to the drive coil in response to the motion impedance being determined.

21. A method according to claim 20 further comprising adjusting frequency of the drive signal to achieve mechanical resonance.

22. A method according to claim 21 wherein the step of adjusting frequency is selected from the group consisting of: adjusting phase of the drive signal or maximizing amplitude.

23. A method according to claim 20 wherein the step of determining total impedance is selected from the group consisting of: measuring voltage or measuring current.

24. A method according to claim 20 wherein the step of filtering out coil impedance from the total impedance comprises training an adaptive filter to match a sensed current in the drive coil given the drive signal and using the adaptive filter to null out the drive signal.
